(19) United States
(12) Patent Application Publication
(10) Pub. No.: US 2014/0380235 A1
(43) Pub. Date: Dec. 25, 2014

(54) IMAGE INSPECTION ASSISTING METHOD AND IMAGE INSPECTION ASSISTING APPARATUS

(71) Applicant: CANON KABUSHIKI KAISHA, Tokyo (JP)

(72) Inventor: Minoru Kusakabe, Yokohama-shi (JP)

(73) Assignee: CANON KABUSHIKI KAISHA, Tokyo (JP)

(21) Appl. No.: 14/345,463

(22) PCT Filed: Nov. 7, 2012
(86) PCT No.: PCT/JP2012/007152

§ 371 Date: Mar. 18, 2014

(30) Foreign Application Priority Data
Nov. 21, 2011 (JP) 2011-254222

(51) Int. Cl. G06F 3/0481; G06F 3/0484

(52) U.S. Cl. CPC G06F 3/0481; G06F 3/04847
USPC 715/799

(57) ABSTRACT

An image inspection assisting apparatus has a first behavior mode in which a display area is allowed to move freely and a second behavior mode in which movement of the display area is restricted. The apparatus determines whether or not a move instruction input by the user instructs a movement within a predetermined non-restricted range when the current behavior mode is the second behavior mode. The movement of the display area is restricted when the move instruction is not an instruction instructing a movement within the non-restricted range.

### TECHNICAL FIELD

The present invention relates to a user interface that assists image inspection in which a captured image of an object is partly displayed, and more particularly to the control of movement of the display area.

### BACKGROUND ART

Displaying methods in which, when a user attempts to move a display area of an image being displayed, the user's instruction to move the display area is restricted, are conventionally known (PTL1). In PTL1, for example, when there are a plurality of images, they can be displayed as thumbnails or individually by changing the magnification. When the magnification is higher than a predetermined level, it is assumed that the user is currently paying attention to a specific one of the images, and display area movement is restricted so that the display area is not inadvertently changed to another image.

### CITATION LIST

### Patent Literature

[PTL 1]
Japanese Patent Application Laid-open No. 2008-268689

### SUMMARY OF INVENTION

### Technical Problem

In PTL1, when there are a plurality of images, the switching between one from another of displayed images is allowed or prohibited by controlling the movement of the display area. The method of PTL1 allows a better small list display of several images and offers better convenience when closely examining a combination of individual images. However, the method of PTL 1 does not involve limiting the operation instructions in order to improve the user friendliness in terms of movement of a display area when inspecting a single image.

When examining images of a high resolution obtained by a microscope or other inspection apparatuses on a screen of a display device, if the display device has a lower resolution than the image itself, or if the drawing area is not large enough, the image cannot be displayed entirely on the screen. Even if the image has a low resolution, the same problem occurs when the image is scaled up. The common approach, therefore, is to display only part of the image on the screen, and this display area is moved about in the image to inspect the whole image. In such inspection work, for better efficiency, it is common to first perform “general check work” wherein the entire image is roughly checked to specify some regions that require close examination, and then to perform “close examination work” wherein the specified regions and the surrounding areas are closely examined. In both of these works, the user visually checks the image while moving the display area. Here, the manipulative functions considered desirable for these work are different. Namely, in the latter close examination work, it is preferable that the user can freely move the display area to anywhere the user wishes to see, while, in the former general check work, it is strongly desired that the entire image is checked all over so that no area is left uninspected. In other words, if the user is allowed to move the display area freely during the general check work, there is a possibility that some parts of the image may be left uninspected (not displayed on the screen), which may be detrimental to the reliability of inspection.

The present invention was made in consideration of the circumstances described above, and it is an object of the invention to enable efficient inspection without omission and to improve the user-friendliness when the user inspects an image on a screen while moving a display area.

### Solution to Problem

The present invention in its first aspect provides an image inspection assisting method for assisting inspection of an image of an object to be inspected, with a partial area of the image being displayed in a display device and the display area being moved within the image, the method comprising: a behavior mode determination step of determining a behavior mode, by means of a computer, from a plurality of behavior modes including a first behavior mode in which the display area is allowed to move freely and a second behavior mode in which movement of the display area is restricted; a move instruction obtaining step of obtaining a move instruction, by means of the computer, that is input by a user and that instructs a movement of the display area; a display area determining step of moving, by means of the computer, the display area based on a current behavior mode and the move instruction obtained in the move instruction obtaining step; and a displaying step of displaying a part of the image corresponding to the moved display area in the display device by means of the computer, the display area determining step including: a step of determining whether or not the move instruction input by the user instructs a movement within a predetermined non-restricted range when the current behavior mode is the second behavior mode, and a step of restricting the movement of the display area when the move instruction is not an instruction instructing a movement within the non-restricted range.

The present invention in its second aspect provides an image inspection assisting method for assisting inspection of an image of an object to be inspected, with a partial area of the image being displayed in a display device and the display area being moved within the image, the method comprising: a move instruction obtaining step of obtaining a move instruction, by means of a computer, that is input by a user and that instructs a movement of the display area; a display area determining step of moving, by means of the computer, the display area based on the move instruction obtained in the move instruction obtaining step; and a displaying step of displaying a part of the image corresponding to the moved display area in the display device by means of the computer, wherein in the display area determining step, when the move instruction is input by the user, the display area is automatically moved along a movement path of the display area set so as to scan the entire image of the object to be inspected consecutively from one end to the other.

The present invention in its third aspect provides an image inspection assisting apparatus for assisting inspection of an image of an object to be inspected, with a partial area of the image being displayed in a display device and the display area being moved within the image, the apparatus comprising: a behavior mode determining unit configured to determine a behavior mode from a plurality of behavior modes including a first behavior mode in which the display area is allowed to move freely and a second behavior mode in which movement of the display area is restricted; a move instruction obtaining unit configured to obtain a move instruction that is input by a user and that instructs a movement of the display area; a display area determining unit configured to move the display area based on a current behavior mode and the move instruction obtained by the move instruction obtaining unit; and a display control unit configured to display a part of the image corresponding to the moved display area in the display device, wherein the display area determining unit determines whether or not the move instruction input by the user is instructing a movement within a predetermined non-restricted range when the current behavior mode is the second behavior mode, and restricts the movement of the display area when the move instruction is not an instruction instructing a movement within the non-restricted range.

The present invention in its fourth aspect provides an image inspection assisting apparatus for assisting inspection of an image of an object to be inspected, with a partial area of the image being displayed in a display device and the display area being moved within the image, the apparatus comprising: a move instruction obtaining unit configured to obtain a move instruction that is input by a user and that instructs a movement of the display area; a display area determining unit configured to move the display area based on the move instruction obtained by the move instruction obtaining unit; and a display control unit configured to display a part of the image corresponding to the moved display area in the display device, wherein when the move instruction is input by the user, the display area determining unit moves the display area automatically along a movement path of the display area set so as to scan the entire image of the object to be inspected consecutively from one end to the other.

The present invention in its fifth aspect provides a program causing a computer to execute each of the steps of the above-described image inspection assisting method.

The present invention enables efficient inspection without omission and improves the user-friendliness when the user inspects an image on a screen while moving a display area.

Further features of the present invention will become apparent from the following description of exemplary embodiments with reference to the attached drawings.

### BRIEF DESCRIPTION OF DRAWINGS

FIG. 1 is a configuration diagram of an imaging system.

FIG. 2 is a configuration diagram of a computer executing an image inspection assisting method.

FIG. 3 is a functional block diagram of an image inspection assisting apparatus of Embodiment 1.

FIG. 4 is a flowchart showing the flow of the image inspection assisting method of Embodiment 1.

FIG. 5 is a flowchart showing the processing at step S409 of FIG. 4 in details.

FIGS. 6A and 6B are diagrams showing the movement control of a display area in a restricted behavior mode in Embodiment 1.

FIG. 7 is a diagram showing the movement control of a display area in an unrestricted behavior mode in Embodiment 1.

FIG. 8 is a functional block diagram of an image inspection assisting apparatus of Embodiment 2.

FIG. 9 is a flowchart showing the flow of the image inspection assisting method of Embodiment 2.

FIG. 10 is a functional block diagram of an image inspection assisting apparatus of Embodiment 3.

FIG. 11 is a flowchart showing the flow of the image inspection assisting method of Embodiment 3.

FIGS. 12A and 12B are diagrams showing the movement control of a display area in Embodiment 3.

FIG. 13 is a flowchart showing the flow of the image inspection assisting method of Embodiment 4.

FIG. 14 is a diagram showing the movement control of a display area in Embodiment 4.

FIG. 15 is a diagram showing an example of the movement path of the display area.

FIG. 16 is a diagram showing an example of the movement path of the display area.

FIG. 17 is a diagram showing an example of the operation range of the display area.

FIGS. 18A to 18C are diagrams showing an example of the operation range of the display area.

FIG. 19 is a diagram showing a display example of an image having a plurality of display areas.

### DESCRIPTION OF EMBODIMENTS

Hereinafter, specific embodiments of an image inspection (examination) assisting method and an image inspection (examination) assisting apparatus (system) according to the present invention will be described with reference to the drawings. A microscope or the like that captures a still image with high resolution will be described below as a specific application example of an imaging apparatus that obtains an image to be inspected. The image inspection assisting method according to the present invention can be applied to inspection of an image captured with high resolution, wherein the entire image is roughly checked first to specify a local region that needs to be closely examined, after which the local region is closely examined.

<System Configuration>

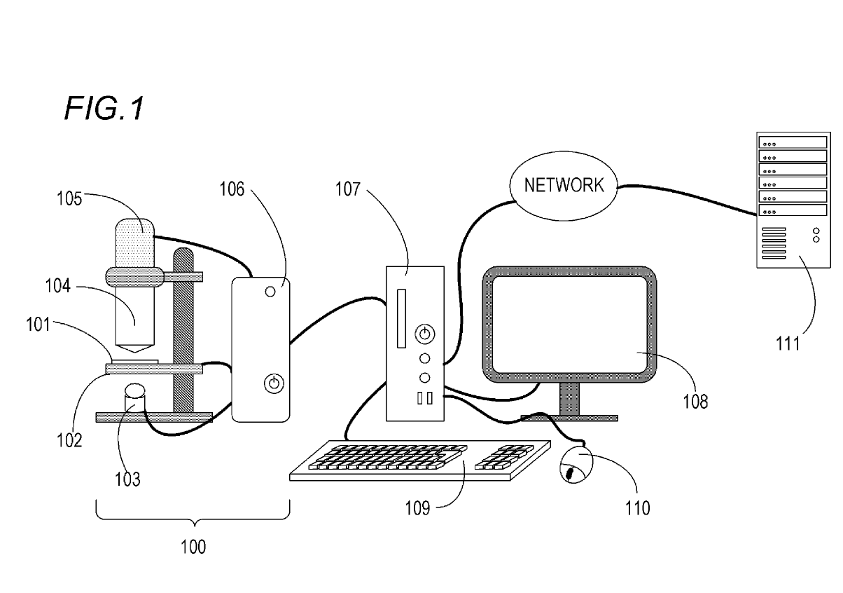

FIG. 1 shows an example of the system configuration of an imaging system according to the present invention. Reference numeral 100 in FIG. 1 denotes a microscope capable of capturing a still image. Reference numeral 101 denotes a slide, which includes a slide glass plate carrying a specimen that is the object, and a cover glass plate for hermetically sealing the specimen. The specimen will be described as a transmissive object in this embodiment. Reference numeral 102 denotes a stage for placing the slide 101 thereon, which can be moved in a plane orthogonal to the direction of the optical axis of the imaging system. The stage 102 can also be moved in the optical axis direction of the imaging system, so that the focal position can be changed in the thickness direction of the object. Reference numeral 103 denotes a light source, and 104 denotes an objective lens. The light source 103 emits light to the objective lens 104 through the slide 101. Reference numeral 105 denotes an imaging unit, which captures an image of the object obtained by the objective lens 104. Reference numeral 106 denotes a controller, which controls the actions of the stage 102, the light source 103, the imaging unit 105, and others. The objective lens 104 may have a plurality of lenses that can be switched, or may have a zooming function. In this case, the controller 106 may control the switching of the lenses or the zooming function. Reference numeral 107 denotes a terminal device for transmitting operation instructions to the microscope 100 and for receiving data of captured images. The system may be configured such that the functions of the controller 106 are realized by the terminal device 107.

Reference numeral 108 denotes a display device that displays a screen for sending operation instructions to the microscope 100, as well as images based on image data obtained by the microscope 100 and analysis results of the image data. Reference numeral 109 denotes a keyboard for an operator to input operation instructions. Reference numeral 110 denotes a mouse for the operator to input operation instructions. Reference numeral 111 denotes a server connected to the terminal device 107 via a network. The server records image data obtained by the microscope 100. The server 111 may be directly connected to the microscope 100 via the network so that the data of captured images is recorded directly in the server 111.

In the embodiments described below, the image inspection assisting method of the present invention is executed by the terminal device 107 and the display device 108 that are separate devices from the microscope 100. Alternatively, the system may be configured such that the microscope 100 includes a display device and means of inputting operation instructions such as buttons in addition to the elements mentioned above, so that the image inspection assisting method of the present invention is executed by the controller 106.

While the specimen carried by the slide 101 is a transmissive object in this embodiment, the present invention is not limited to this.

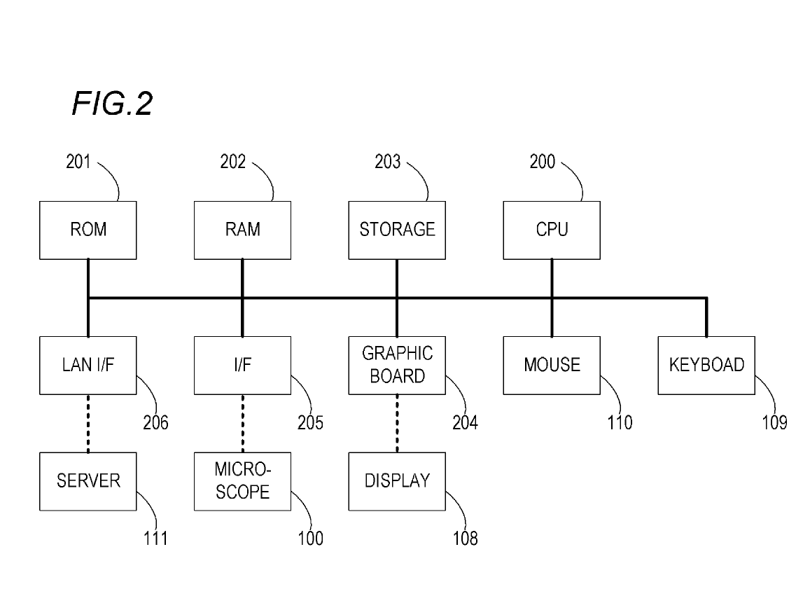

FIG. 2 shows the internal configuration of the terminal device 107, which is a computer that executes the image inspection assisting method, and the relationships with external devices. Reference numeral 200 denotes a CPU, which performs arithmetic operations necessary for the processing. Reference numeral 201 denotes a ROM that stores programs and data which can be read out by the CPU 200. Reference numeral 202 denotes a RAM which the CPU 200 can write in, or read out from, programs or data necessary for the processing. Reference numeral 203 denotes a storage configured by an HDD or SSD which the programs and image data can be written in or read out from. Reference numeral 204 denotes a graphic board that generates display data for displaying a screen. Reference numeral 205 denotes an interface that sends and receives data when the terminal device 107 communicates with the microscope 100 which is an external device. Reference numeral 206 denotes a LAN interface that sends and receives data when the terminal device 107 communicates with the server 111 connected to the network. Such a terminal device 107 can be configured by a general-purpose computer.

In the embodiments described below, the CPU 200 executes a program stored in the ROM 201 and the storage 203 so that the terminal device 107 executes the image inspection assisting method and functions as the image inspection assisting apparatus.

### Embodiment 1

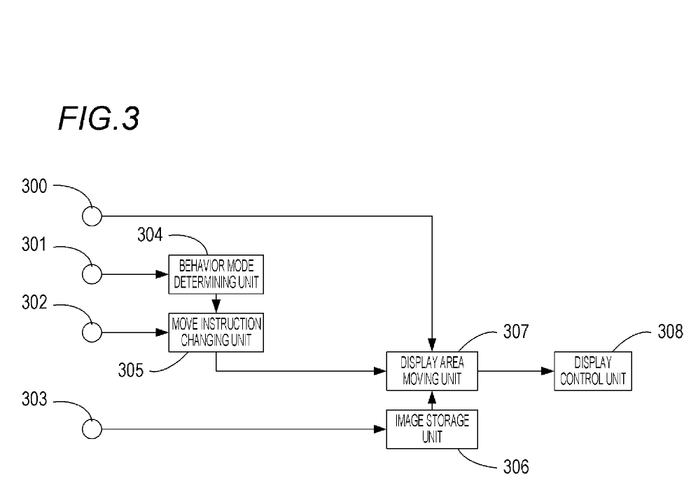

FIG. 3 is a functional block diagram showing the functional configuration of the image inspection assisting apparatus of Embodiment 1 of the present invention. Reference numeral 300 denotes an input terminal for inputting a display magnification. A display magnification designated by a user using the keyboard 109 or the mouse 110 is input to the input terminal 300. Reference numeral 301 denotes a behavior mode input terminal. A behavior mode instruction designated by a user using the keyboard 109 or the mouse 110 is input to the behavior mode input terminal 301. Reference numeral 302 denotes a move instruction input terminal. A move instruction designated by a user using the keyboard 109 or the mouse 110 to move a display area in an image as will be described later is input to the move instruction input terminal 302. Reference numeral 303 denotes an image input terminal. Image data obtained by the imaging apparatus 100 is input to the image input terminal 303.

Reference numeral 304 denotes a behavior mode determining unit, which is a function to determine a behavior mode in accordance with a behavior mode instruction input from the behavior mode input terminal 301. In this embodiment, there are a plurality of behavior modes at least including a first behavior mode that allows the display area to be freely moved and a second behavior mode that limits movement of the display area. The first behavior mode is suited to close examination work, while the second behavior mode is suited to general check work. The first behavior mode will be referred to as unrestricted behavior mode, and the second behavior mode as restricted behavior mode in the following description.

Reference numeral 305 denotes a move instruction changing unit, which is a function to change the contents of a move instruction input to the move instruction input terminal 302 based on a behavior mode determined by the behavior mode determining unit 304. Reference numeral 306 denotes an image storage unit that stores image data input to the image input terminal 303. Reference numeral 307 denotes a display area moving unit, which computes a display area based on a move instruction output from the move instruction changing unit 305 and generates image data to be displayed by obtaining image information from the image storage unit 306 based on the computed display area information. The move instruction changing unit 305 and the display area moving unit 307 form a display area determining unit. Reference numeral 308 denotes a display control unit, which displays an image by drawing the image data to be displayed generated by the display area moving unit 307 in a drawing area of the display device 108.

The image storage unit 306 is typically configured by the RAM 202, or the storage 203, of the terminal device 107. Instead, the image storage unit 306 may be configured outside the terminal device 107, in which case the terminal device 107 does not need to have the function of the image storage unit 306. In the absence of the image storage unit 306, the display area moving unit 307 obtains necessary image data directly from the image input terminal 303.

(Movement Control of Display Area)

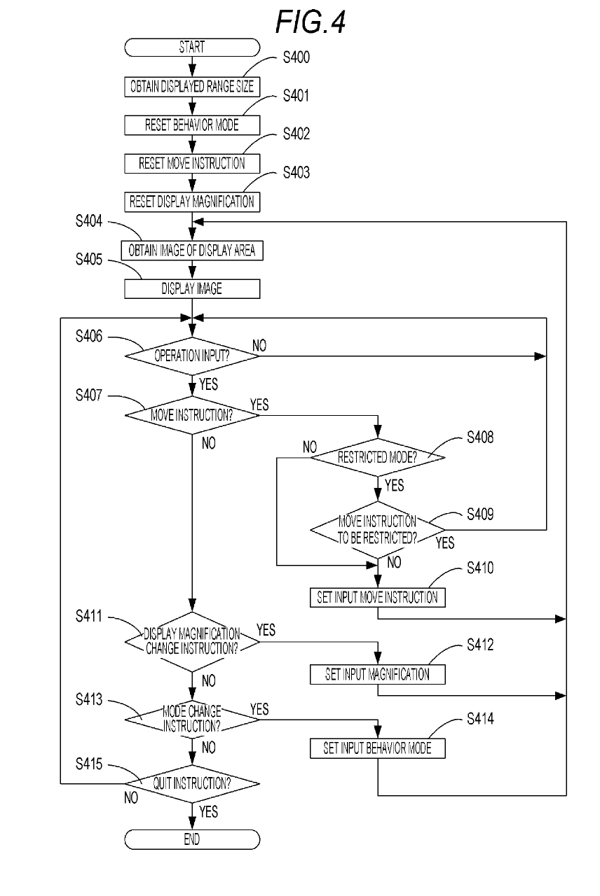

FIG. 4 is a flowchart showing the operation flow of the image inspection assisting method of this embodiment. The process starts with initialization in preparation for display. At step S400, the size of the displayed range in the display window is obtained. At step S401, the behavior mode is reset. At step S402, the contents of the move instruction are reset to determine an initial position of the display area. At step S403, the display magnification is reset.

At step S404, the display area moving unit 307 obtains image data corresponding to the current display area in the image from the image storage unit 306, based on the size of the displayed range in the display window, the position of the display area in the image, and the display magnification. At step S405, the display control unit 308 changes the magnification of the image obtained at step S404 as required to match the display size on the display device and displays the image.

Step S406 determines whether or not an operation instruction has been input by the user. In the absence of an operation instruction, the system waits until an operation instruction is given. If there has been an operation instruction, the process proceeds to step S407. Step S407 determines whether or not the operation instruction was a move instruction to move the display area, and if yes, the process proceeds to step S408.

At step S408, the move instruction changing unit 305 determines whether or not the current behavior mode is the restricted behavior mode (second behavior mode), and if yes, the process proceeds to step S409. At step S409, the move instruction changing unit 305 determines whether or not the move instruction to move the display area is an instruction to be restricted, judging from its contents (i.e., whether or not the direction or amount of movement instructed by the user meets predetermined conditions). If it is a move instruction to be restricted, the move instruction changing unit 305 deletes (ignores) the move instruction by the user, and proceeds to step S406, without moving the display area. If the behavior mode is determined not to be the unrestricted behavior mode at step S408, or if the instruction is determined not to be the move instruction to be restricted at step S409, the process proceeds to step S410. Step S410 sets a location of the display area after being moved as instructed by the input move instruction, and the process proceeds to step S404.

If the operation instruction is not a move instruction to move the display area at step S407, the process proceeds to step S411, which determines whether or not the operation instruction has been an instruction to change the display magnification, and if yes, the process proceeds to step S412. At step S412, the input display magnification is stored as a magnification to be used from the next time onwards, and the process proceeds to step S404.

If the operation instruction was not an instruction to change the display magnification at step S411, the process proceeds to step S413, which determines whether or not the operation instruction was an instruction to change the behavior mode. If the operation instruction was an instruction to change the behavior mode, then the behavior mode determining unit 304 stores an input behavior mode as a behavior mode to be used from the next time onwards at step S414, and the process proceeds to step S404. On the other hand, if the operation instruction was not an instruction to change the behavior mode at step S413, the process proceeds to step S415, which determines whether or not the operation instruction was an instruction to end the process. If the operation instruction was not an instruction to quit the process at step S415, the process proceeds to step S406 to wait for a next operation instruction. If the operation instruction was an instruction to end the process, the display operation is ended.

The flow of FIG. 4 shows only the processing steps necessary for the movement control of a display area, which is the characteristic feature of this embodiment. In actual practice, the process may handle other instructions other than the operation instructions shown in FIG. 4 and include additional steps as required. The order of the steps S407, S411, and S413 is not limited to the one shown in FIG. 4, and they may be performed in different orders. Step S407 in this embodiment corresponds to a move instruction obtaining step, steps S408 to S410 correspond to a display area determining step, steps S413 and S414 correspond to a behavior mode determining step, and steps S404 and S405 correspond to a display control step.

(Determining if the Move Instruction is to be Restricted)

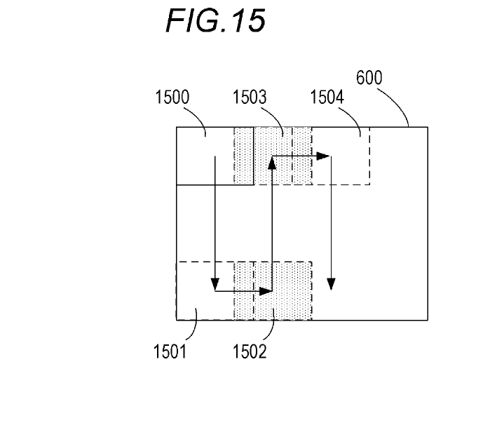

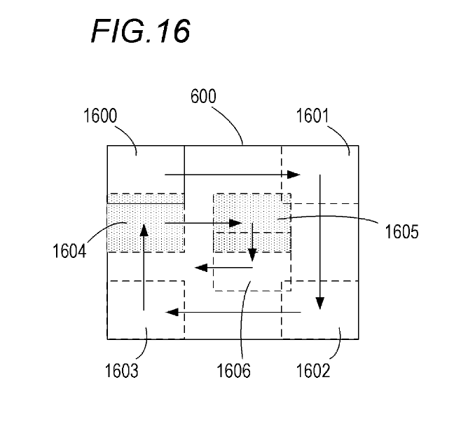

If the current behavior mode is the restricted behavior mode, step S409 determines whether or not the move instruction by the user is an instruction to be restricted as described above. This processing step can be realized by setting an unrestricted range (where the movement of the display area is not restricted) on the image, and by determining whether or not the move instruction by the user is instructing a movement within this unrestricted range. The unrestricted range may be set any way as long as the movement of the display area is controlled so that there will be no area in the image left uninspected. In this embodiment, for example, as will be described below, a movable range (i.e., unrestricted range) is set parallel to a predetermined moving direction from the current position of the display area as a reference point. With this method, the unrestricted range changes dynamically in accordance with the current position of the display area. Alternatively, as will be described later, a movement path of the display area (i.e., unrestricted range) may be set such that the image of an object being inspected will be scanned consecutively from one end to the other, and the display area may be allowed only to move along this path (see FIG. 15 and FIG. 16).

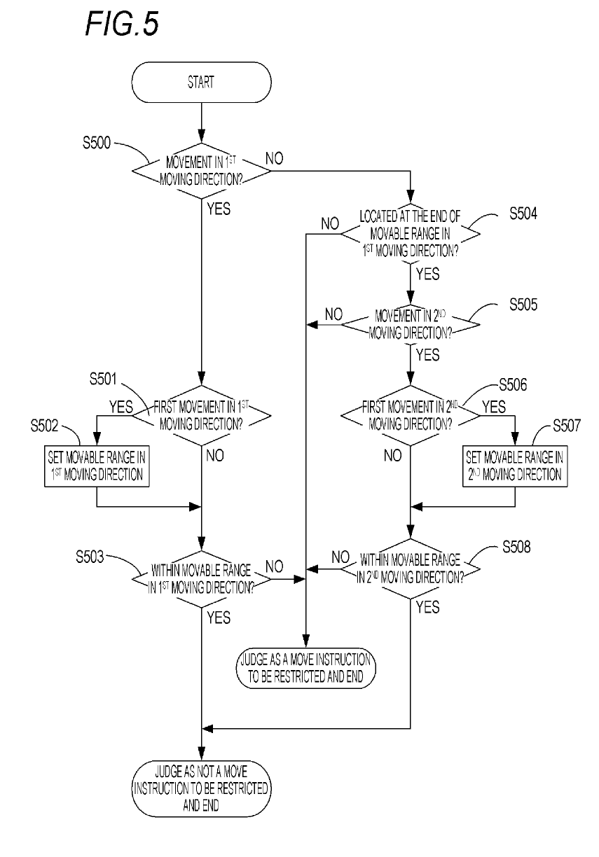

FIG. 5 is a flowchart for explaining the processing at step S409 in this embodiment in detail. When the operation of step S409 is started, the move instruction changing unit 305 determines at step S500 whether or not the move instruction is instructing a movement in a first moving direction to be described later. If it is determined as a movement in the first moving direction, the move instruction changing unit 305 determines at step S501 whether or not this movement is a first movement in the first moving direction from the current position in a second moving direction. If it is determined as the first movement in the first moving direction at step S501, the move instruction changing unit 305 computes and sets a movable range in the first moving direction by the following method at step S502. If step S501 determines that this is not the first movement, or when the processing at step S502 is performed, the process proceeds to step S503. At step S503, the move instruction changing unit 305 determines whether or not the destination of the movement as instructed by the move instruction is within the movable range in the first moving direction, and if yes, the unit decides that the move instruction is not to be restricted and ends the processing. If the destination is determined to be not within the movable range at step S503, the unit decides that the move instruction is to be restricted and ends the processing.

If step S500 determines that the move instruction is not instructing a movement in the first moving direction, then the move instruction changing unit 305 determines at step S504 whether or not the display area is currently located at an end of the movable range in the first moving direction. If step S504 determines that the display area is located at the end, the move instruction changing unit 305 determines at step S505 whether or not the move instruction is instructing a movement in the second moving direction. If step S505 determines that the movement is to be in the second moving direction, the move instruction changing unit 305 determines at step S506 whether or not this movement is a first movement in the second moving direction from the current position in the first moving direction. If step S506 determines that this is the first movement in the second moving direction, the move instruction changing unit 305 computes and sets a movable range in the second moving direction by the following method at step S507. If step S506 determines that this is not the first movement, or when the processing at step S507 is performed, the process proceeds to step S508. At step S508, the move instruction changing unit 305 determines whether or not the destination of the movement as instructed by the instruction is within the movable range in the second moving direction, and if yes, the unit decides that the move instruction is not to be restricted and ends the processing. If the destination is determined to be not within the movable range at step S508, the unit decides that the move instruction is to be restricted and ends the processing. If step S504 determines that the display area is not located at the end, or if step S505 determines that the instruction is not instructing a movement in the second moving direction, then the unit decides that the move instruction is to be restricted and ends the processing.

If the move instruction is decided to be restricted, the instruction is deleted (ignored) in this embodiment. Instead, the contents of the move instruction (moving direction or moving amount) may be automatically corrected so that the display area will stay within the movable range after being moved. For example, when the moving direction selected by the move instruction is neither the first moving direction nor the second moving direction, the contents of the move instruction may be divided into components of the first moving direction and the second moving direction, and only one of these components may be adopted as a move instruction so that the display area will move within the movable range. Or, if the moving amount or destination selected by the move instruction is such that the display area will be out of the movable range, then the moving amount may be reduced, or the destination may be changed, so that the display area will stay within the movable range after being moved. With such an automatic correction of the contents of the move instruction, the user friendliness can be improved even more.

(Restricted Behavior Mode)

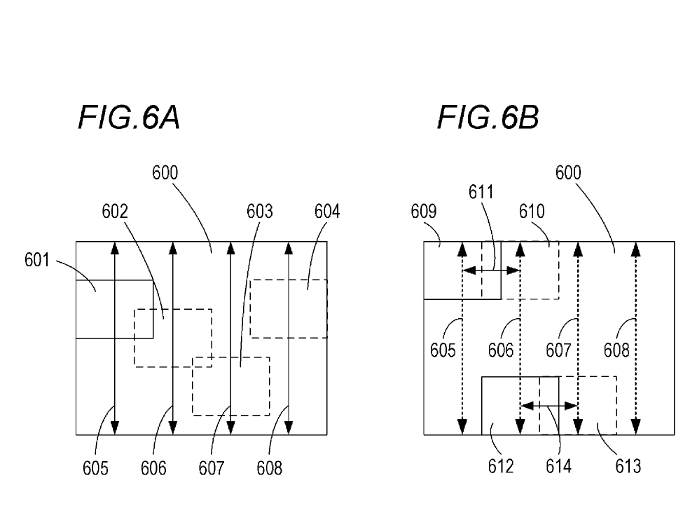

FIG. 6A and FIG. 6B illustrate the captured image data, display areas, and how the display area is moved in the operations in the restricted behavior mode, which is the characteristic feature of this embodiment. FIG. 6A is a diagram given for explanation of a movable range (unrestricted range) in a first moving direction set at step S502 in FIG. 5. Reference numeral 600 in FIG. 6A denotes the entire image data. Reference numerals 601 to 604 denote examples of display area, which are different from each other at least in lateral (horizontal) position relative to the image data 600. Reference numerals 605 to 608 denote movable directions and ranges respectively corresponding to the display areas 601 to 604 located at different lateral positions. The movable directions indicated by 605 to 608 are parallel to the predetermined first moving direction, which is vertical (perpendicular) relative to the image data in the example of FIG. 6A. The movable range in the first moving direction is between the upper and lower ends of the image data.

In the example of FIG. 6A, all the display areas 601 to 604 are located other than the upper and lower ends in the movable directions. Upon receiving a move instruction from the user to move the display area, the move instruction changing unit 305 changes the display area as instructed if the instruction meets the conditions that the moving direction is parallel to the first moving direction as indicated by 605 to 608, and that the display area will be included in the range between the upper and lower ends of the image after the movement. If a move instruction is given to move the display area in a direction that is not parallel to the first moving direction, then the move instruction changing unit 305 does not move the display area. Likewise, even though the instructed moving direction is parallel to the first moving direction, if the display area will be located outside the movable range after being moved, the move instruction changing unit 305 does not move the display area. A movement to outside of the range may be restricted such that the display area is allowed to move within a range in which it is completely inside the image, or, such that the display area is allowed to move within a range in which at least part of the display area is included in the image.

FIG. 6B is a diagram given for explanation of a movable range (unrestricted range) in a second moving direction set at step S507 in FIG. 5. The second moving direction is orthogonal to the first moving direction in this embodiment. In FIG. 6B, the display areas 609, 610, 612, and 613 are located at the upper or lower end of the image data 600. The display areas 609 and 601, display areas 610, 612, and 602, and display areas 613 and 603, are located at the same positions in the second moving direction. In the case of FIG. 6B, the display areas 609, 610, 612, and 613 can move not only in the first moving direction (605 to 607) but also in the second moving direction (611 and 614) orthogonal to the first moving direction. As indicated by 611 and 614, the movable range in the second moving direction is equal to or less than the length along the second moving direction of the display area. Namely, the display area is allowed to move only in a range in which there will be no gap formed between the current display area and the one after it is moved in the second moving direction. Therefore, if the current display area is at 609, and if the move instruction from the user to move the display area meets the requirements of the directions and ranges indicated by 605 and 611, the display area is moved as instructed. On the other hand, if the move instruction from the user to move the display area does not meet the requirements of the directions and ranges indicated by 605 and 611, the display area is not moved, or moved only to a limit position of the movable range.

If the user wishes to check continuity of the image when inspecting the image, it is desirable that the image is displayed with the display areas having an overlapping region. In such a case, the movable ranges 611 and 614 parallel to the second moving direction may be made shorter than the length in the second moving direction of the display area.

While FIG. 6B shows only the display area 609 on the left side of the display area 610 as its destination in the second moving direction, the display area 610 may be moved to the same direction as the display area 613 in the lateral direction (right side). The display area 609, however, which is at the upper left end of the image data, will be out of the image data if it is moved to the opposite direction (left side) from the display area 610. Therefore, if a move instruction instructs to move a display area at an end in the second moving direction of the image data in a direction in which the display area will be out of the image data, such instruction may be rejected, or, the display area may be moved in a range in which part of the image data will be displayed.

While the first moving direction is vertical to the image data and the second moving direction is lateral to the image data in the examples of FIG. 6A and FIG. 6B, the present invention is not limited to this. The lateral direction of the image data may be the first moving direction, for example. Alternatively, the first moving direction may not be preliminarily determined but may be selected by the user.

While the display area is allowed to move in the second moving direction only at the ends of the first moving direction, this may also apply vice versa, i.e., the display area may be allowed to move in the first moving direction only at the ends of the second moving direction. Namely, in the example of FIG. 6B, the display area may be allowed to switch its moving direction only at the end positions of 605 to 608, 611, and 614, and not allowed to switch its direction at an intermediate position.

(Unrestricted Behavior Mode)

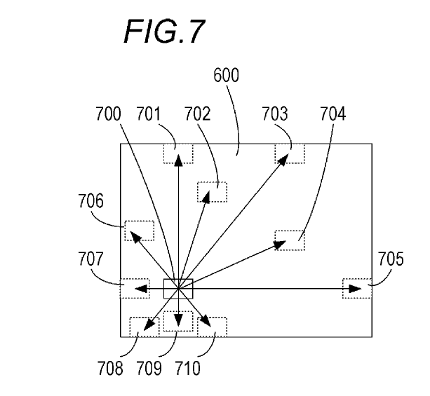

FIG. 7 illustrates the captured image data, display areas, and how the display area is moved in the operations in the unrestricted behavior mode, which is the characteristic feature of this embodiment.

Reference numeral 600 denotes the entire image data similarly to FIG. 6A. Reference numeral 700 denotes the current display area. Reference numerals 701 to 710 denote display areas located at given positions within the range of the entire image data 600. In the unrestricted behavior mode, there is no restriction on the move instruction from the user to move the display area. Namely, the user can move the display area a given amount in a given direction. Although not described with reference to FIG. 4 and FIG. 7, movements to outside of the range of the image data may be restricted also in the unrestricted behavior mode in a similar manner as described in the foregoing with reference to FIG. 6A and FIG. 6B.

With Embodiment 1 of the present invention, general check work performed such as not to leave out any region, and close examination work wherein the display area is freely moved, can be switched to and from each other, by selecting an behavior mode that determines presence or absence of restriction on the movement of the display area during image inspection. The method described in this embodiment may be effective, for example, when conducting general check work of an entire object in the image, and conducting a close examination, after that, of a region that needs to be closely examined. More specifically, the user may select the restricted behavior mode for general checking, and the unrestricted behavior mode for close examination. Such selection of mode allows for omission-free general check work without having to manipulate while making fine adjustments. Also, the selection of mode suitable for the close examination allows for free, unrestricted, and efficient movement of the display area to portions that need to be closely examined.

### Embodiment 2

In Embodiment 1, an example of switching between restricted and unrestricted movement of the display area was described, the switching being done by the user selecting an behavior mode that determines presence or absence of movement restriction when moving the display area during image inspection. In this embodiment, an example of automatically switching the behavior modes in accordance with the display magnification by the terminal device 107 (behavior mode determining unit) to improve the efficiency of image inspection work will be described.

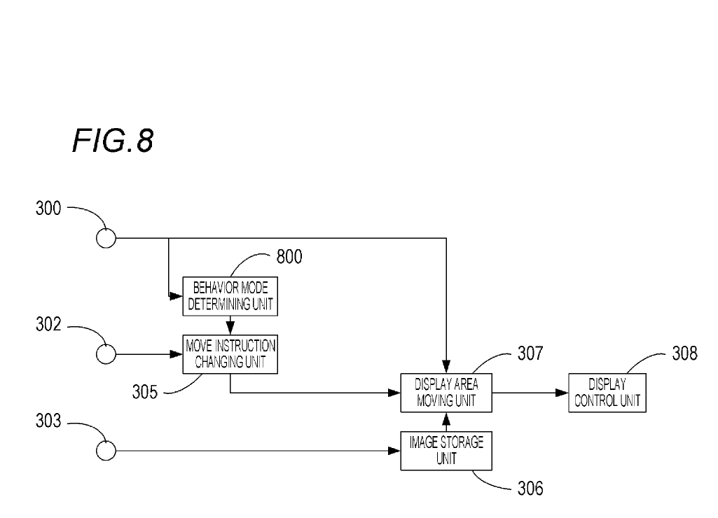

FIG. 8 is a functional block diagram showing the functional configuration of the image inspection assisting system of Embodiment 2 of the present invention. Elements similar to those in FIG. 3, which is the block diagram of Embodiment 1, are given the same reference numerals and will not be described again. Reference numeral 800 in FIG. 8 denotes an behavior mode determining unit, which has a function of determining an behavior mode in accordance with a display magnification input from the display magnification input terminal 300.

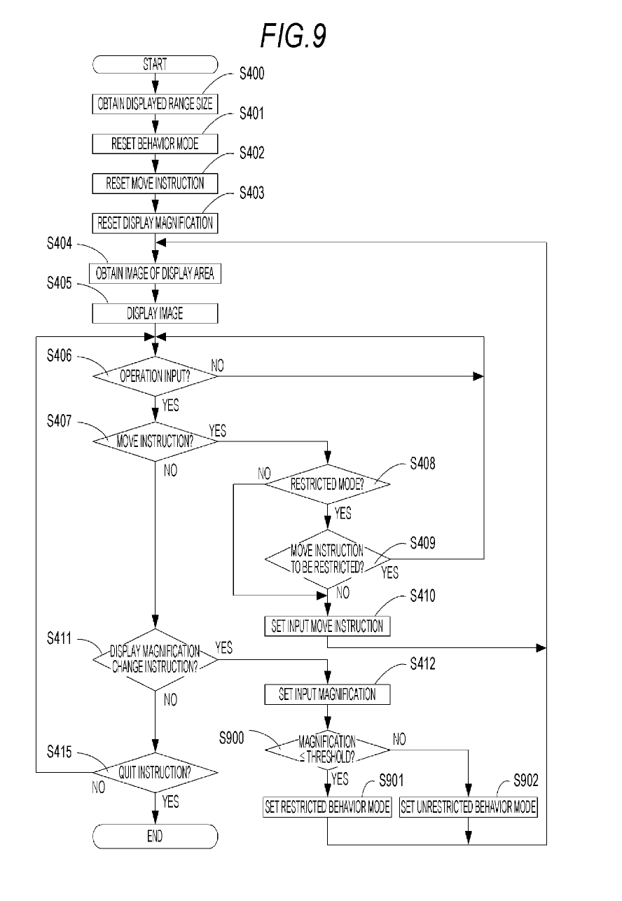

FIG. 9 is a flowchart showing the operation flow of the image inspection assisting method of this embodiment. Elements similar to those in FIG. 4, which is the flowchart of Embodiment 1, are given the same reference numerals and will not be described again. Since the behavior modes are switched in accordance with a display magnification in this embodiment, processing steps corresponding to steps S413 and S414 in FIG. 4 are deleted. The processing after step S412, which is performed when step S411 determines that an input operation instruction is an instruction to change the display magnification, is different from that of FIG. 4.

When the input display magnification is set at step S412, the process proceeds to step S900. At step S900, the behavior mode determining unit 800 determines whether or not the current display magnification is less than a predetermined threshold. If it is less than a threshold, the behavior mode determining unit 800 sets the restricted behavior mode at step S901 as the behavior mode to be used from the next time onwards. If the current display magnification is determined not to be less than the predetermined threshold at step S900, the behavior mode determining unit 800 sets the unrestricted behavior mode at step S902 as the behavior mode to be used from the next time onwards.

With this embodiment, efficient check work during image inspection is possible when, for example, general check work is first conducted with a relatively low display magnification, after which close examination is performed with a relatively high display magnification only to a region that needs to be closely examined. More specifically, during the general check work for spotting a region that needs close examination, the image data needs to be checked thoroughly so that no region is left out. As a result of the general check work, when several regions are determined to need close examination, and these regions are dispersed away from each other within the image data, it is necessary to move the display area freely to efficiently check each of these regions that need close examination. Therefore the restricted behavior mode is adopted for a relatively low display magnification, and the unrestricted operation is adopted for other cases, so that the position of the display area can be changed in a manner suited to the respective check work without the user having to select the behavior mode. A predetermined value may be used for the threshold of the display magnification based on which the behavior modes are switched. Further, the threshold of the display magnification may be set such that it can be changed by the user, so that the threshold can be set for the display magnification suitably for each object, as the display magnifications for general checking and close examination may differ depending on the object. As a result, the image inspection work can be performed efficiently.

In the method of the example described above, the restricted behavior mode is adopted when the display magnification is relatively low, but the present invention is not limited to this. For example, in the case with handling a specimen that requires a relatively high magnification to be checked generally, the restricted behavior mode may be adopted for the magnification used for the general check work. In this case, the operation efficiency will be better if the display area can be changed unlimitedly with a magnification lower than the magnification used for the general check work. Therefore, the restricted behavior mode is adopted for a relatively high display magnification, while the unrestricted behavior mode is adopted for a relatively low display magnification. For a magnification higher than the magnification used for the general check work, it is preferable to adopt the restricted behavior mode when the display magnification is higher than a predetermined first threshold and lower than a predetermined second threshold, considering that close examination will be performed similarly to the foregoing example. Predetermined values may be used for the first threshold and the second threshold, or the thresholds may be set such that they can be changed by the user.

### Embodiment 3

In Embodiment 2 above, an example of automatically switching the behavior modes in accordance with the display magnification was described. In Embodiment 3, an example of switching the behavior modes based on whether or not the display area, after being moved as instructed by an operation instruction, has already been displayed there before. The method of this embodiment is based on a consideration that a region that is displayed first time needs to be checked generally so that no area is left out, and that a region that needs close examination is selected from regions that have already been displayed once during the general check work.

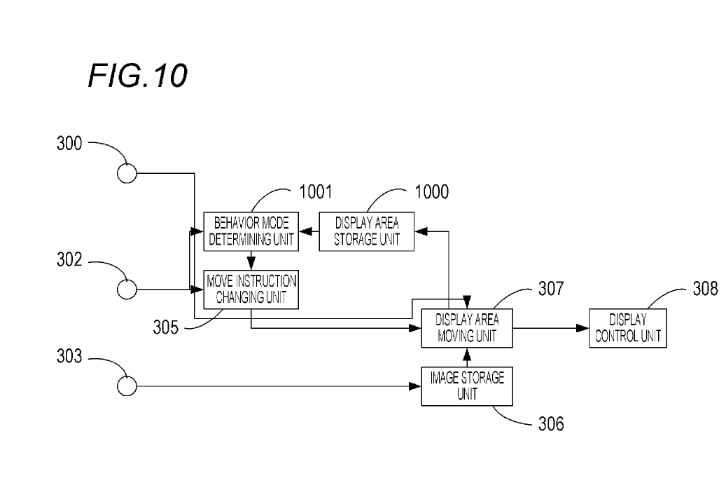

FIG. 10 is a functional block diagram showing the functional configuration of the image inspection assisting system of Embodiment 3. Elements similar to those in FIG. 3 and FIG. 8, which are the block diagrams of Embodiment 1 and Embodiment 2, are given the same reference numerals and will not be described again.

In FIG. 10, reference numeral 1000 denotes a display area storage unit that stores already-displayed region information computed at the display area moving unit 307. Reference numeral 1001 denotes a behavior mode determining unit, which decides a behavior mode based on the move instruction input from the move instruction input terminal 302 and the already-displayed region information obtained from the display area storage unit 1000.

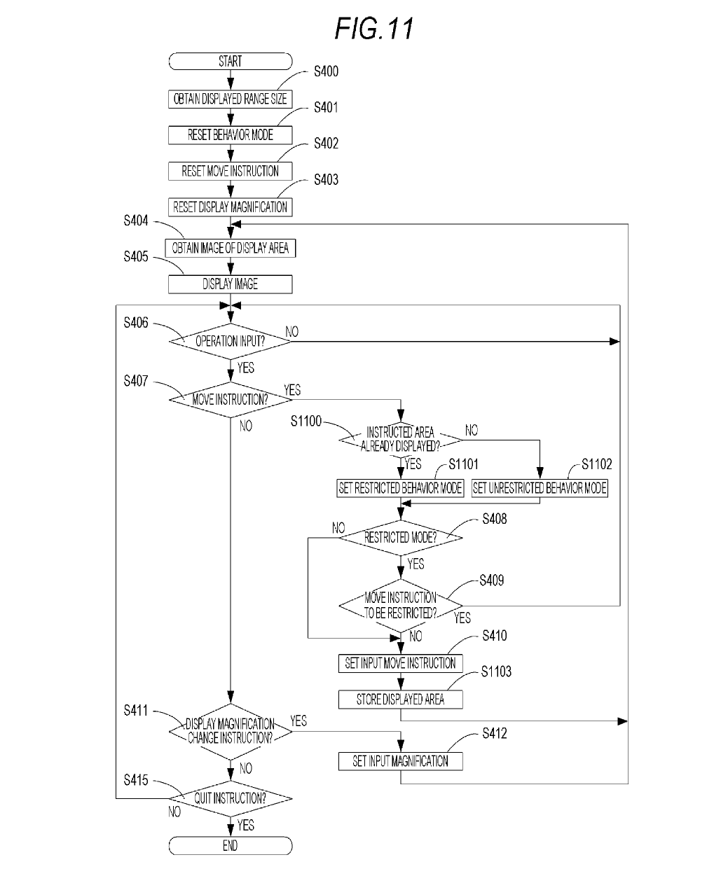

FIG. 11 is a flowchart showing the operation flow of the image inspection assisting method of this embodiment. Elements similar to those in FIG. 4 and FIG. 9, which are the flowcharts of Embodiment 1 and Embodiment 2, are given the same reference numerals and will not be described again. In this embodiment, since the behavior modes are not switched in accordance with a user instruction or a display magnification, processing steps corresponding to steps S413 and S414 in FIG. 4, or steps S900 to S902 in FIG. 9, are deleted. The processing when an operation instruction is determined as a move instruction instructing to move the display area at step S407 is different from those of FIG. 4 and FIG. 9.

When an operation instruction is determined as a move instruction instructing to move the display area at step S407, the behavior mode determining unit 1001 determines at step S1100 whether or not the display area, if moved as instructed by the move instruction, has already been displayed there before. Information on already-displayed regions is obtained from the display area storage unit 1000. If the display area is determined as having already been displayed there, the behavior mode determining unit 1001 sets the unrestricted behavior mode at step S1101. If the display area is determined as not having been displayed there yet, the behavior mode determining unit 1001 sets the restricted behavior mode at step S1102. At step S1100, the behavior mode determining unit 1001 preferably determines that the display area has already been displayed at the moved location only when the entire display area has been displayed there before. Alternatively, the behavior mode determining unit 1001 may determine that the display area has already been displayed at the moved location if even a portion of the display area has been displayed there before.

When the behavior mode is set at step S1101 or at step S1102, the process proceeds to step S408, followed by the processing as described in the foregoing until step S410. When an input move instruction is set at step S410, the process proceeds to step S1103, where the display area moving unit 307 stores already-displayed region information in the display area storage unit 1000. When the processing at step S1103 is complete, the process proceeds to step S404.

In some cases, carrying out a move instruction may involve moving a display area partly through an already-displayed region to a non-displayed region. For such cases, step S1100 may determine whether or not a region has been displayed before not just once at the start of the instruction but at predetermined regular intervals, or every time when the display area is moved a predetermined amount. Alternatively, the move instruction may be separately determined for an already displayed region and a non-displayed region. For example, when the display area will be moving partly through an already-displayed region to a non-displayed region, the move instruction by the user may be divided into two move instructions, one for the movement from the current display area to the boundary between the already-displayed region and non-displayed region, and the other for the movement from the boundary to the instructed position. The behavior mode would then be decided first based on the determination of “already displayed” and then based on “not displayed yet” when moving to the non-displayed region.

Conversely, if carrying out a move instruction involves moving a display area partly through a non-displayed region to an already-displayed region, then the behavior mode may be decided first based on the determination of “not displayed yet” and then based on “already displayed” when moving to the already displayed region.

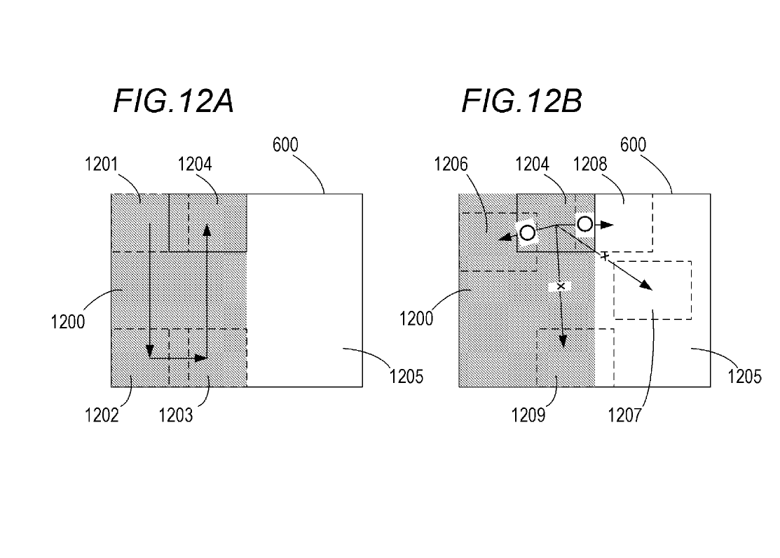

FIG. 12A and FIG. 12B illustrate the captured image data, display areas, and how the display area is moved in the behavior modes with an already-displayed region, which is the characteristic feature of this embodiment. Reference numeral 600 in FIG. 12A and FIG. 12B denotes the entire image data. FIG. 12A illustrates the already-displayed region and non-displayed region of the entire image data 600. In FIG. 12A, the hatched area denoted by 1200 is the already-displayed region. Reference numerals 1201 to 1204 indicate the display area as it is moved. In the following description, it is assumed that the current display area is at 1204, having moved in the order of 1201, 1202, 1203, and 1204. When the display area has moved from 1201 to 1204, the area denoted by 1200 is the region that has already been displayed. Reference numeral 1205 denotes a non-displayed region, which is a region other than the already-displayed region 1200 of the entire image data 600.

FIG. 12B illustrates the already-displayed region 1200, the non-displayed region 1205, and the display area as it is moved. Reference numeral 1206 denotes a region of the same size as 1204 that is entirely contained in the already-displayed region 1200, so that when the display area is instructed to move from 1204 to 1206, it will be a movement within the already-displayed region. In this case, the unrestricted behavior mode is applied so as to allow free operation by the user. Reference numeral 1207 denotes a region of the same size as 1204 that is entirely contained in the non-displayed region 1205, so that when the display area is instructed to move from 1204 to 1207, it will be a movement out of the already-displayed region. In this case, the restricted behavior mode is applied to prohibit the movement to 1207. The current display area is allowed to move from 1204 to the non-displayed region 1205 in a specific direction in a specific range at an end portion as described, for example, with reference to FIG. 6. In the case with FIG. 12B, it can move to 1208. Reference numeral 1209 denotes a region of the same size as 1204 that bridges across both of the already-displayed region 1200 and the non-displayed region 1205. When the display area is instructed to move from 1204 to 1209, the restricted behavior mode is preferably applied similarly to the movement to 1207, since 1209 is contained in the non-displayed region 1205.

The already-displayed region 1200 is illustrated as a rectangle in FIG. 12A and FIG. 12B for simplification of description. However, the already-displayed regions that are actually stored can have various shapes. In a process in which the display area is being moved from 1203 to 1204, for example, the already-displayed region would be stored as an L-shaped region without the upper right part. Moreover, when the display magnification is changed, the area of the image data that is being displayed will change, so that the already-displayed region that is stored will have a further complex shape.

While the behavior mode is changed based on a determination of whether or not the display area will be in an already-displayed region after being moved in this embodiment, the present invention is not limited to this. For example, when the display magnification is reduced to enlarge the display range of the image data, the display area will be enlarged and may include a region that has not been displayed yet. In such a case, the behavior mode may be switched based on a change in the display magnification instead of a movement of the display area, i.e., the current behavior mode may be changed to the restricted behavior mode. Conversely, when the display magnification is increased to reduce the display area of the image data, the display area will be smaller and may be included in an already-displayed region. In such a case, too, the current behavior mode may be changed to the unrestricted behavior mode, based on a change in the display magnification. In this way, when it is desired to check a nearby non-displayed region additionally during a close examination at an end portion of an already-displayed region in the unrestricted behavior mode, it is possible to switch to an behavior mode suited to the work being done. Namely, it is possible to automatically change from the unrestricted behavior mode to the restricted behavior mode when the display magnification is reduced to enlarge the display range so that unexamined regions are newly displayed. Also, it is possible to change to a behavior mode suited to the work being done in such a case when the display magnification is temporarily increased to perform close examination during general check work wherein new unexamined regions are displayed one after another in the restricted behavior mode. Namely, it is possible to automatically change from the restricted behavior mode to the unrestricted behavior mode when the display magnification is increased to reduce the display range so that display area is entirely included in the already-displayed region.

While the behavior mode is changed based on a display history in this example, the present invention is not limited to this, and Embodiment 1 or other behavior mode switching schemes described in Embodiment 2 may be used in combination. For example, the behavior modes may be first switched in accordance with the method of Embodiment 1, or Embodiment 2. When the current behavior mode is the restricted mode, the determination may be made further based on the display history, and if the display area is to be moved to an already-displayed region, the behavior mode may be switched again to the unrestricted mode. This way, when the unrestricted behavior mode is set first, the display area can be moved freely irrespective of the display history, so that the display area can be moved to a desired location efficiently. When the restricted behavior mode is set first, one of the restricted behavior mode and the unrestricted behavior mode can be set based on the display history. The display area can thus be moved efficiently without omission of a region depending on how the image is displayed.

Conversely, the determination may be made further based on the display history only when the unrestricted behavior mode has been selected in the method of Embodiment 1 or Embodiment 2, and if the display area is to be moved to a non-displayed region, the behavior mode may be switched again to the restricted behavior mode. This way, when the restricted behavior mode is set first, the display area can be moved freely irrespective of the display history without omission, so that the general check work can be performed reliably without the possibility of omission. When the unrestricted behavior mode is set first, one of the restricted behavior mode and the unrestricted behavior mode can be set based on the display history. The display area can thus be moved efficiently without omission of a region depending on how the image is displayed.

In this embodiment, the behavior modes are switched based on whether or not the display contents, when changed as instructed by an operation instruction, have already been displayed before. Consequently, the display area is prohibited to move in such a way as to allow omission, when it is moved to a region which one cannot confirm has already been checked, so that omission of inspection can be prevented. Moreover, the display area can be freely moved to a region that has already been checked so as to allow efficient check work.

### Embodiment 4

In Embodiments 1 to 3, examples of limiting the direction or amount of movement of the display area when the restricted behavior mode is adopted were described. In this embodiment, examples of changing the speed of moving the display area when the restricted behavior mode is adopted will be described.

The functional block diagram of this embodiment would be the same as that of Embodiment 1 in FIG. 3, the only difference from Embodiment 1 being that the contents of the move instruction the move instruction changing unit 305 changes in FIG. 3 are not the direction and amount of movement but the speed of movement.

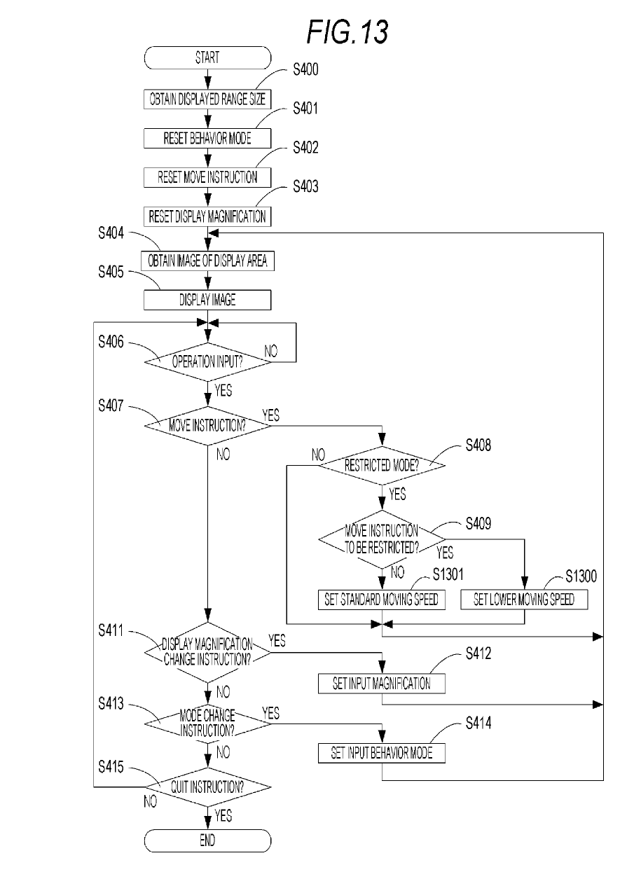

FIG. 13 is a flowchart showing the operation flow of the image inspection assisting method of this embodiment. Elements similar to those in FIG. 4, which is the flowchart of Embodiment 1, are given the same reference numerals and will not be described again. FIG. 13 is different from FIG. 4 in the processing performed after the current mode is determined as the restricted moving mode at step S408. When the current behavior mode is determined as the restricted behavior mode at step S408 and when the move instruction is determined as the instruction to be restricted at step S409, the move instruction changing unit 305 sets a low speed for the movement of the display area at step S1300. On the other hand, when the move instruction is determined not to be the instruction to be restricted at step S409, the move instruction changing unit 305 sets a standard moving speed for the movement of the display area at step S1301. Predetermined values may be used for the low moving speed and the standard moving speed mentioned above, or the speeds may be selected by the user beforehand.

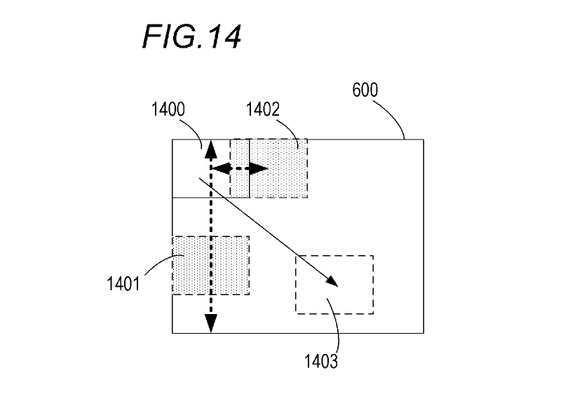

FIG. 14 illustrates the captured image data, display areas, and how the display area is moved in various directions and with speeds in the restricted behavior mode, which is the characteristic feature of this embodiment. Reference numeral 1400 denotes the current display area. Reference numerals 1401 and 1402 denote examples of display areas in a region where the display area is allowed to move with the standard speed in the restricted behavior mode. The display area is moved in directions and ranges similar to those in the restricted behavior mode described in the foregoing with reference to FIG. 6A and FIG. 6B. Reference numeral 1403 denotes a display area contained in a region to which it is not allowed to move with the standard speed in the restricted moving mode. When the display area is moved from 1400 to 1401 or 1402, it can be moved with the standard moving speed. On the other hand, when the display area is moved from 1400 to 1403, it is moved with a speed lower than the standard moving speed.

In this embodiment, one example of switching the moving speeds of the display area in the restricted behavior mode described in Embodiment 1 has been described. However, this embodiment is not limited to this. For example, the switching of the moving speeds of the display area shown in this embodiment may be applied to the behavior mode in the method described in Embodiment 2, or Embodiment 3. When adopting the method of switching the behavior modes based on the display history of Embodiment 3, the already-displayed regions may be stored constantly, or alternatively, the already-display regions may be stored only when the moving speed is the standard speed. This way, the regions where the display area is moved at low speed will not be stored, so that the moving speed will stay low in regions other than the region where the display area is moved at the standard speed. As a result, when the same region is displayed repeatedly and when the user moves the display area out of a region where omission is unlikely to occur, it is easier for the user to notice.

With this embodiment, when the display area is being moved such as not to leave out any region, such as during general checking, a movement of the display area whereby omission may occur is allowed exceptionally, while this movement is distinguished from a movement whereby no omission will occur. Moreover, as the moving speed of the display area is made low for such an exceptional operation, the user can recognize that it is an exceptional operation, and also omission can be minimized.

### Other Embodiments

The present invention is not limited to Embodiments 1 to 4 described above and there may be various other embodiments.

The embodiment described above with reference to FIG. 6B showed a case where the movement of the display area is allowed in the second moving direction when it is located at an end portion of a movable range in the first moving direction. There are other possible cases where the location of the display area where it is allowed to move in the second moving direction is not limited to the end portion of the movable range. For example, it may be decided whether or not the movement in the second moving direction should be allowed based on the display conditions of a movable range parallel to the first moving direction, for example. More specifically, if, in FIG. 6B, for example, the image has been displayed at all the locations in the movable range 605, the display area is allowed to move to the movable range 606, which is a movement in the second moving direction, at any given location. On the other hand, if there is a portion in the movable range 605 that has not been displayed yet, the movement in the second moving direction is not allowed. The amount of movement allowed in the second moving direction may be set such as to prevent omission similarly to the case described in connection with the movable range 611 in the embodiment above. This way, the movement in the second moving direction is allowed from a location other than the end portions, so that, even if an image component that requires attention existed somewhere other than the end portions of the first moving direction, it can be inspected without interruption particularly in the second moving direction.

In the embodiments described above, the contents of the move instruction changed by the move instruction changing unit 305 were the direction, amount, or speed of movement. However, the contents of the move instruction changed by the move instruction changing unit 305 may be acceleration of movement, for example. Also, the contents of the move instruction changed by the move instruction changing unit 305 may be continuity of movement of displayed locations, i.e., in the unrestricted behavior mode the displayed locations are changed continuously, whereas in the restricted behavior mode the displayed locations are changed discontinuously at predetermined intervals. In short, the contents of the move instruction changed by the move instruction changing unit 305 may be anything, as long as the change will make the user recognize that the user's operation instruction, if executed, may possibly cause some parts of the screen to be left undisplayed.

As another embodiment, in the behavior mode in which the movement of the display area is restricted, the display area may be allowed to move only along a predetermined movement path. The movement path is set such as to scan the entire image of the object being inspected consecutively from one end to the other. The movement path may for example be the one shown in FIG. 15, or FIG. 16. In the example of FIG. 15, the entire image data 600 is scanned in a zigzag fashion in the order of 1500, 1501, 1502, 1503, 1504, etc. In the example of FIG. 16, the entire image data 600 is scanned from its outer rim consecutively toward inside in the order of 1600, 1601, 1602, 1603, 1604, 1605, 1606, etc. The movement path is not limited to the example of FIG. 15 or FIG. 16, and it may be any path as long as the entire image can be scanned without omission. The movement path need not necessarily be predetermined, but may be selected by the user before the scan. In this case, the behavior mode switching based on the method described in Embodiment 3 may be used in combination, and the display area may be allowed to move freely in an already-displayed region. Embodiment 4 may also be used in combination, and the moving speed may be lowered for a movement out of the movement path. The movement path may be predetermined before the image inspection, so that different images can be inspected along the same movement path of the display area.

If the movement path is determined before the image inspection as mentioned above, the operation instruction by the user can further be simplified. More specifically, instead of using a mouse or a keyboard to instruct a moving direction, the user can press a specific button to cause the display area to move automatically along the predetermined path. The specific button may be one of the buttons on the mouse or keyboard. One example would be to press down one of the buttons for instructing a moving direction during close examination to execute the movement. It goes without saying that other buttons than those for instructing a moving direction during close examination may be used. In this case, the display area may move only when a button is being pressed, or, pressing a button once may start it and keep it moving even though the button is released, and pressing the button again may stop the movement. This movement by pressing a specific button may not only be applied to a case where general check work and close examination work are combined but also to image inspection where only general check work is done. In this case, the behavior mode switching is not performed, and the work only involves moving the display area along a predetermined path. The operation instruction by the user can thus be simplified by predetermining a movement path and moving the display area by only pressing a specific button.

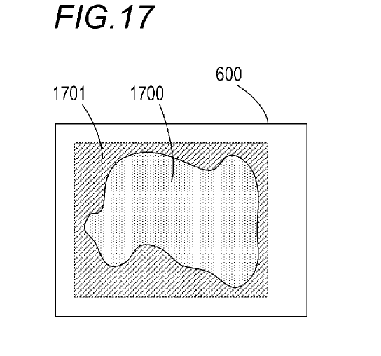

In a yet another embodiment, for example, the range of inspection (operation range in which the display area is moved) may be limited during the restricted behavior mode described with reference to FIG. 6A and FIG. 6B. FIG. 17 is a diagram showing one example of limiting the operation range, in which reference numeral 1700 denotes a specimen carried on the slide 101. Reference numeral 1701 denotes a range in which the specimen 1700 is entirely included. While the display area was moved within the entire image data 600 as explained with reference to FIG. 6A and FIG. 6B in the foregoing embodiments, this range may be limited to 1701. The operation range 1701 may be determined by analyzing the image data to detect the specimen 1700 from the entire image data 600 based on, for example, color, brightness, or edges, and by computing a minimum rectangle containing this specimen 1700. If there are likely to be errors in detecting the specimen, the range may not necessarily be defined by a minimum rectangle but with sufficient room so that the specimen will certainly be contained. In short, the operation range 1701 need only be smaller than the size of the original image data 600. Alternatively, the user may be able to select the operation range 1701. In this case, the user can also select only a part of the specimen, rather than the entire region containing the specimen 1700. If the range where the specimen 1700 exists (i.e., range that needs to be inspected) is known in advance, the operation range may be set automatically (without image data analysis or specification by the user).

The shape of the limited range need not necessarily be a rectangle but other shapes such as, for example, a parallelogram, various polygons, or a circle. In this case, the second moving direction need not be orthogonal to the first moving direction as in the previous embodiments.

Limiting the operation range as described above makes it possible to pay attention only to a necessary region in the entire image data 600 in the image inspection and to eliminate wasted time in the work.

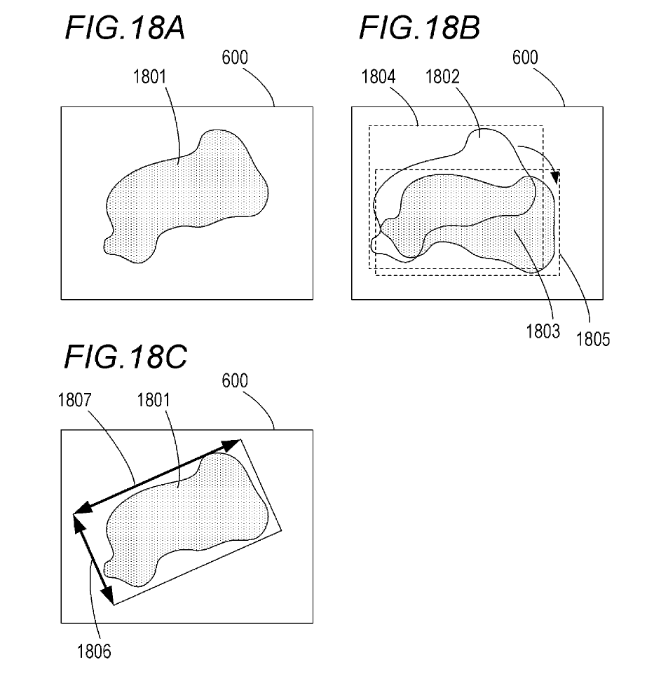

In a further embodiment, rotation may be taken into account. More specifically, the specimen may sometimes be oriented in an undesirable manner in the input image data. Or, when limiting the range to eliminate unnecessary regions as described above, it may sometimes be possible, by taking rotation into account, to reduce the range by cutting unnecessary regions where the specimen does not exist. In this case, taking rotation into account enables reduction of unnecessary regions and improves the work efficiency. FIG. 18A to FIG. 18C are diagrams showing examples of taking rotation into account. Reference numeral 1801 in FIG. 18A denotes a specimen. FIG. 18B shows an example of rotating the image data of FIG. 18A, rotation being done prior to the operation described above. Reference numeral 1802 denotes the specimen before the rotation, and reference numeral 1803 denotes the specimen after the rotation. If the moving direction of the display area in the restricted behavior mode is vertical and horizontal to the entire image data 600, the rectangular range 1805 containing 1803 is smaller than the rectangular range 1804 containing 1802. The inspection range in the restricted behavior mode can thus be made smaller.

FIG. 18C shows an example in which the user can set the first moving direction and the second moving direction. Namely, this is an example of rotating the movable directions rather than the image information. Reference numerals 1806 and 1807 denote the first moving direction and the second moving direction, respectively, which are both not vertical and horizontal to the entire image data 600. By making the moving directions freely settable as shown in FIG. 18C, regions where no specimen is present in the operation range can be reduced. Here, only the first moving direction may be selected, with the second moving direction being set orthogonal to the first moving direction. Alternatively, both of the first and second moving directions may be set, in which case the second moving direction need not necessarily be orthogonal to the first moving direction.

Another method in a further embodiment is to display the region that has been determined as “already displayed” in a smaller area than has actually been displayed, during the restricted movement of the display area in the restricted behavior mode, or during the restricted movement of the display area based on the movement history. When a sufficiently smaller region in the currently display area is being observed with much attention, it is sometimes necessary to compare the region with surrounding regions. In such a case, if this region that needs attention is being displayed at an end of the screen, images of surrounding regions that are the target of comparison may be out of the screen and not displayed, so that the region that needs to be checked with attention may need to be moved generally to the center of the screen. In this case, if the entire image displayed on the screen is determined as an already displayed region, parts of the image at the periphery that are not suited for the checking will also be determined as “already displayed”, because of which proper checking may not be carried out. Therefore, only a predetermined range near the center of the image displayed on the screen will be determined whether or not it has been displayed. The omission-free movement restriction of the display area may be applied to this predetermined range near the center, so that the region that can actually be checked can reliably be displayed without omission.

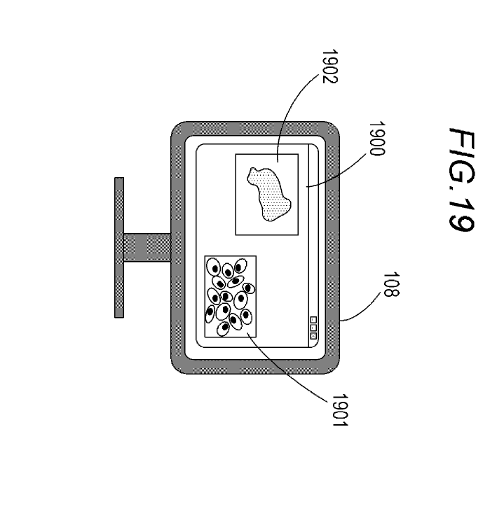

In a yet another embodiment, the invention may be applied in displaying the same or different images side by side in a plurality of drawing areas for displaying images at different locations in an application window that appears on the display device 108, for example. A window 1900 may have a first drawing area 1901 and a second drawing area 1902 as shown in FIG. 19, and images with the display area described above are drawn in each of the drawing areas. The drawing areas may be configured such that different positions or scales of a single image are displayed side by side, or different images are displayed side by side. The display area may be moved, or the display magnification may be changed, independently in each of the first drawing area 1901 and the second drawing area 1902. Characteristic parts in the images displayed in the first drawing area 1901 and the second drawing area 1902 are compared, as the images are checked. In this case, the behavior mode should preferably be settable separately for the respective drawing areas. With the behavior mode set for each of the drawing areas, the movement restriction of the display area should preferably be set independently for the images drawn in the drawing areas. This way, the omission-free movement, or free movement, of the display area in one drawing area will not be affected by the behavior mode set when checking the image drawn in the other drawn area. While a plurality of drawing areas exist in one window in the example described with reference to FIG. 19, the present invention is not limited to this, and a plurality of windows may each have the drawing area, for example.

While the embodiments above have been described as being realized by a program executed by a CPU 200, the present invention is not limited to this. Part or all of the functions described above may be configured by hardware.

While a microscope was mentioned as an example of an imaging apparatus, the present invention is not limited to this, and may be applied to images obtained using various other apparatuses. The present invention can be used in various applications where omission-free general check work of an image and close examination work of a specific region with efficient movement of the display area are performed in combination.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-254222, filed on Nov. 21, 2011, which is hereby incorporated by reference herein in its entirety.

1. An image inspection assisting method for assisting inspection of an image of an object to be inspected, with a partial area of the image being displayed in a display device and the display area being moved within the image,
the method comprising:
a behavior mode determining step of determining a behavior mode, by means of a computer, from a plurality of behavior modes including a first behavior mode in which the display area is allowed to move freely and a second behavior mode in which movement of the display area is restricted;
a move instruction obtaining step of obtaining a move instruction, by means of the computer, that is input by a user and that instructs a movement of the display area;
a display area determining step of moving, by means of the computer, the display area based on a current behavior mode and the move instruction obtained in the move instruction obtaining step; and
a displaying step of displaying a part of the image corresponding to the moved display area in the display device by means of the computer,
the display area determining step including:
a step of determining whether or not the move instruction input by the user instructs a movement within a predetermined non-restricted range when the current behavior mode is the second behavior mode, and
a step of restricting the movement of the display area when the move instruction is not an instruction instructing a movement within the non-restricted range.

2. The image inspection assisting method according to claim 1, wherein, in the display area determining step, at least one of direction, amount, and speed of movement is restricted in moving the display area when the move instruction is not an instruction instructing a movement within the non-restricted range.

3. The image inspection assisting method according to claim 1, wherein, in the display area determining step, if the move instruction is an instruction instructing a movement within the non-restricted range, then a location of the display area after being moved as instructed is set, and if not, the display area is not moved, or a location of the display area after being moved is set within the non-restricted range.

4. The image inspection assisting method according to claim 1, wherein, in the display area determining step, if the move instruction is an instruction instructing a movement within the non-restricted range, then the moving speed of the display area is set to a standard moving speed, and if not, the moving speed of the display area is set lower than the standard moving speed.

5. The image inspection assisting method according to claim 1, wherein, in the behavior mode determining step, a behavior mode is determined in accordance with an instruction input from the user to change the behavior mode.

6. The image inspection assisting method according to claim 1, further comprising a step of changing magnification of the image displayed in the display device, by means of the computer, based on an instruction input from the user to change the display magnification, wherein
in the behavior mode determining step, a behavior mode is changed in accordance with the display magnification.

7. The image inspection assisting method according to claim 6, wherein, in the behavior mode determining step, if the display magnification is not higher than a predetermined threshold, then the second behavior mode is selected, and if not, the first behavior mode is selected.

8. The image inspection assisting method according to claim 1, further comprising a step of storing in a storage device an area in the image displayed in the displaying step as an already-displayed region by means of the computer, wherein
in the behavior mode determining step, if a location of the display area if moved as instructed by the move instruction is not included in the already-displayed region, then the second behavior mode is selected, and if not, the first behavior mode is selected.

9. The image inspection assisting method according to claim 1, further comprising a step of setting by means of the computer an operation range smaller than the image of the object to be inspected, wherein in the display area determining step, when the current behavior mode is the second behavior mode, the display area is restricted to move only within the operation range.

10. The image inspection assisting method according to claim 1, wherein the non-restricted range is defined by a movement path of the display area set so as to scan the entire image of the object to be inspected consecutively from one end to the other.

11. (canceled)

12. An image inspection assisting apparatus for assisting inspection of an image of an object to be inspected, with a partial area of the image being displayed in a display device and the display area being moved within the image, the apparatus comprising:
a behavior mode determining unit configured to determine a behavior mode from a plurality of behavior modes including a first behavior mode in which the display area is allowed to move freely and a second behavior mode in which movement of the display area is restricted;
a move instruction obtaining unit configured to obtain a move instruction that is input by a user and that instructs a movement of the display area;
a display area determining unit configured to move the display area based on a current behavior mode and the move instruction obtained by the move instruction obtaining unit; and
a display control unit configured to display a part of the image corresponding to the moved display area in the display device, wherein
the display area determining unit determines
whether or not the move instruction input by the user is instructing a movement within a predetermined non-restricted range when the current behavior mode is the second behavior mode, and
restricts the movement of the display area when the move instruction is not an instruction instructing a movement within the non-restricted range.

13. (canceled)

14. A non-transitory computer readable storage medium storing a program causing a computer to execute each of the steps of the image inspection assisting method according to claim 1.
